(19) United States
(12) Patent Application Publication
(10) Pub. No.: US 2013/0332537 A1
(43) Pub. Date: Dec. 12, 2013

(54) DYNAMICALLY MODIFYING PARTICIPANTS IN AN ONLINE CHAT SESSION

(71) Applicants: Earl W. Emerick, Rochester, MN (US); Jeffrey A. Schmidt, Rochester, MN (US); Rawls W. Walden, II, Rochester, MN (US)

(72) Inventors: Earl W. Emerick, Rochester, MN (US); Jeffrey A. Schmidt, Rochester, MN (US); Rawls W. Walden, II, Rochester, MN (US)

(73) Assignee: INTERNATIONAL BUSINESS MACHINES CORPORATION, Armonk, NY (US)

(21) Appl. No.: 13/489,711

(22) Filed: Jun. 6, 2012

(51) Int. Cl. G06F 15/16

(52) U.S. Cl. 709/206

(57) ABSTRACT

In a method for managing an online chat session, an instant message received from a customer participating in the online chat session is examined. A determination that the examined instant message indicates characteristic of a problem being experienced by the customer is made. One or more chat participants to include in the online chat session to address the problem are determined based on the characteristic of the problem. A set of chat participants participating in the online chat session is modified to include the determined one or more chat participants in the set of chat participants.

### TECHNICAL FIELD

The present invention relates generally to the field of digital communications, and more particularly to dynamically modifying participants in an online chat session.

### BACKGROUND

Instant messaging and online chat systems are popular digital communication systems for many people, and provide for real-time communication between users who are connected to such systems through an online or electronic networking environment, such as the Internet or a corporate intranet. Instant messaging and online chat communication systems deliver electronic messages in real-time from message senders to message recipients. For example, a text-based instant message usually appears in a pop-up online chat window on the message recipient's computer screen almost as soon as the message sender clicks the send button. Therefore, the message recipient is able to view the message without having to access an email program or otherwise manually check for messages.

Increasingly, online chat services have been used to enable company or organization representatives to communicate with visitors to that company's or organization's website. For example, online chat services are sometimes used to help a visitor complete a purchase or to provide a customer with support for a product or service. In order to initiate a chat session, a customer submits a message through the company's or organization's website to a chat server. Typically, the company or organization provides a number of representatives for dealing with customer queries. The chat server will allocate the received message to the next available representative, who will join the chat session and exchange instant messages with the customer in an attempt to deal with the customer's queries.

### SUMMARY

In one embodiment, a method to manage an online chat session is provided. The method includes a computer examining an instant message received from a customer participating in the online chat session. The method further includes the computer determining that the examined instant message indicates a characteristic of a problem being experienced by the customer. The method further includes the computer determining, based on the characteristic of the problem, one or more chat participants to include in the online chat session to address the problem. The method further includes the computer modifying a set of chat participants participating in the online chat session. The modifying comprises including the determined one or more chat participants in the set of chat participants.

In another embodiment, a computer program product to manage an online chat session is provided. The computer program product includes one or more computer readable-tangible storage devices and program instructions stored on at least one of the one or more computer readable-tangible storage devices. The program instructions include program instructions to examine an instant message received from a customer participating in the online chat session. The program instructions further include program instructions to determine that the examined instant message indicates a characteristic of a problem being experienced by the customer. The program instructions further include s program instructions to determine, based on the characteristic of the problem, one or more chat participants to include in the online chat session to address the problem. The program instructions further include program instructions to modify a set of chat participants participating in the online chat session. The program instructions to modify the set of chat participants include program instructions to include the determined one or more chat participants in the set of chat participants.

In another embodiment, a computer system to manage an online chat session is provided. The computer system includes one or more processors, one or more computer-readable memories, one or more computer readable-tangible storage devices and program instructions which are stored on the one or more computer readable-tangible storage devices for execution by the one or more processors via the one or more memories. The program instructions include program instructions to examine an instant message received from a customer participating in the online chat session. The program instructions further include program instructions to determine that the examined instant message indicates a characteristic of a problem being experienced by the customer. The program instructions further include program instructions to determine, based on the characteristic of the problem, one or more chat participants to include in the online chat session to address the problem. The program instructions further include program instructions to modify a set of chat participants participating in the online chat session. The program instructions to modify the set of chat participants include program instructions to include the determined one or more chat participants in the set of chat participants.

### BRIEF DESCRIPTION OF THE SEVERAL VIEWS OF THE DRAWINGS

FIG. 1 is a functional block diagram of a distributed data processing environment, including a user computing device and a network server computer, in accordance with an embodiment of the present invention.

FIG. 2 is an exemplary depiction of stored information in a database, in accordance with an embodiment of the present invention.

FIG. 3 is a flowchart illustrating the steps of a chat participant modifying program for dynamically modifying participants in an online chat session, in accordance with an embodiment of the present invention.

FIG. 4 provides an exemplary depiction of an online chat session populated using a chat participant modifying program, in accordance with an embodiment of the present invention.

FIG. 5 shows a block diagram of internal components and external components of a user computing device and internal components and external components of a network server computer, in accordance with an illustrative embodiment of the present invention.

### DETAILED DESCRIPTION

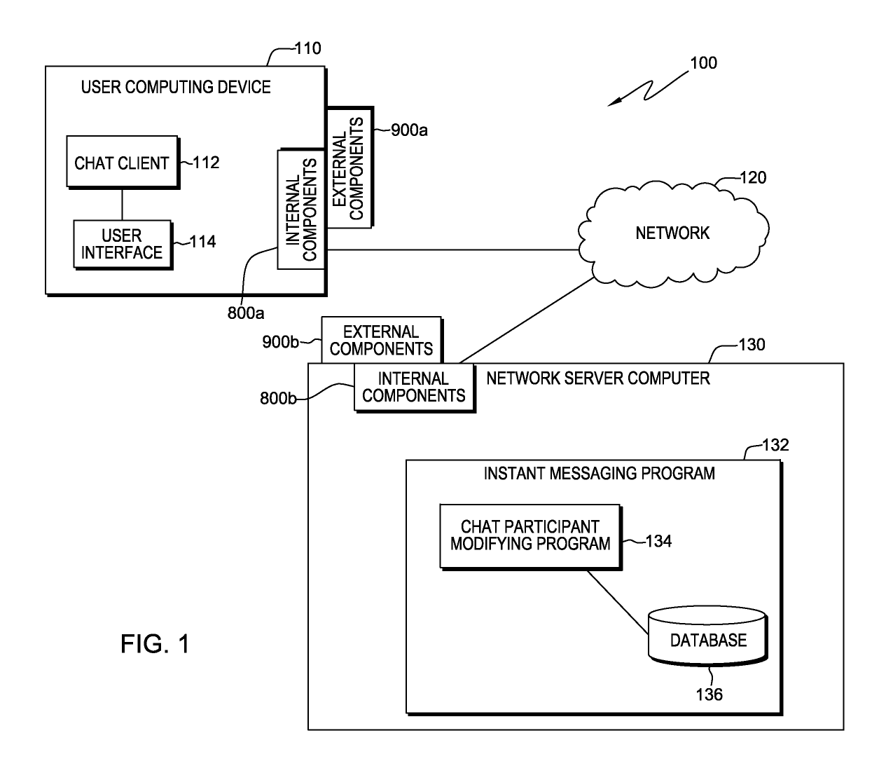

FIG. 1 is a functional block diagram of a distributed data processing environment, including a user computing device and a network server computer, in accordance with an embodiment of the present invention. Distributed data processing environment 100 includes user computing device 110 and network server computer 130. User computing device 110 and network server computer 130 are interconnected over network 120.

Network 120 can be, for example, a local area network (LAN), a wide area network (WAN) such as the Internet, or a combination of the two, and can include wired, wireless, or fiber optic connections. In general, network 120 can be any combination of connections and protocols that will support communications between user computing device 110 and network server computer 130.

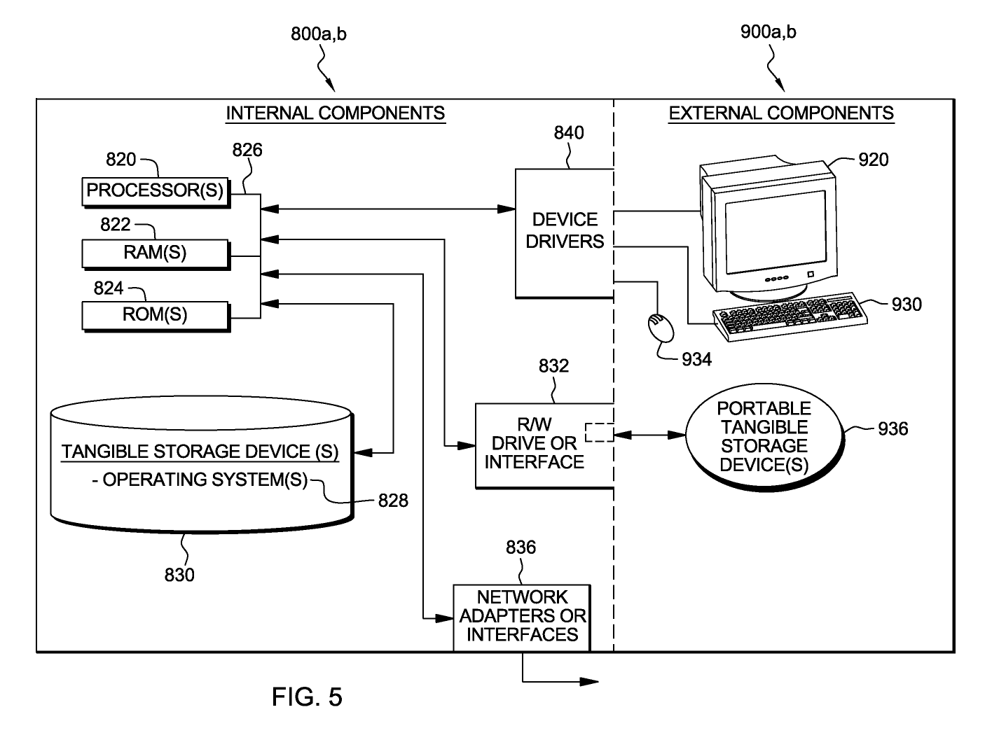

In various embodiments of the present invention, user computing device 110 can be a laptop computer, tablet computer, netbook computer, personal computer (PC), desktop computer, personal digital assistant (PDA), smart phone, or any programmable electronic device capable of communicating with network server computer 130 via network 120. User computing device 110 may include internal components 800a and external components 900a, as depicted and described in further detail with respect to FIG. 5. User computing device 110 includes chat client 112 and user interface 114.

Chat client 112 is a program that offers a user of user computing device 110 online chat capabilities by communicating with a corresponding messaging service on a separate computer, e.g., instant messaging program 132 residing on network server computer 130. In a preferred embodiment, chat client 112 is a web-browser based client, which is downloaded to user computing device 110 when visiting the relevant web page. User interface 114 provides an interface that displays text, user options and instructions for operation of chat client 112. User interface 114 may be, for example, a graphical user interface (GUI) or a web user interface (WUI). While in FIG. 1, chat client 112 is shown as being separate from user interface 114, one of skill in the art will appreciate that in other embodiments, chat client 112 includes user interface 114.

Network server computer 130 may contain internal components 800b and external components 900b, as depicted and described in further detail with respect to FIG. 5. In various embodiments of the present invention, network server computer 130 may be a server computer, laptop computer, tablet computer, netbook computer, personal computer (PC), desktop computer, personal digital assistant (PDA), smart phone, or any programmable electronic device capable of communicating with user computing device 110 via network 120. Network server computer 130 includes instant messaging program 132, which includes chat participant modifying program 134 for managing chat participants in an online chat session. While FIG. 1 depicts instant messaging program 132 as including chat participant modifying program 134, one of skill in the art will appreciate that, in other embodiments, chat participant modifying program 134 is external to, and can communicate with, instant messaging program 132.

Instant messaging program 132 operates to communicate instant messages over a network, such as network 120, for exchange in a chat session. Chat participant modifying program 134 manages who participates in the chat session by dynamically adding participants to and/or removing participants from the chat session to resolve a situation present in the chat session. The chat session is made up of one or more participants who are available to chat and to work through the situation present in the chat session by discussing and addressing problem characteristics involved in the situation.

In managing who participates in the chat session, chat participant modifying program 134 examines instant messages received from chat client 112, via network 120, to determine one or more chat participants for the chat session. Chat participant modifying program 134 examines the received instant messages for certain signifiers which may signify either a problem characteristic or a customer profile, both of which may be used to determine chat participants for the chat session. Examples of signifiers that signify a problem characteristic are problem characteristic indicators which include, but are not limited to, certain words, phrases, symbols, characters, images, user names or locations. An example of a signifier that signifies a customer profile is message sender identifying information, such as a user name or an account number.

Problem characteristic indicators and message sender identifying information are stored in database 136. In one embodiment, database 136 may be located on network server computer 130. In an alternative embodiment, database 136 may be located on a storage device accessible to network server 130 via network 120. Database 136 contains problem characteristics linked to problem characteristic indicators and customer profiles associated with message senders. Also contained in database 136 are lists of potential chat participants associated with either customer profile information or with roles or skills necessary to address various problem characteristics. Chat participant modifying program 134 determines, based on the information stored in database 136, potential chat participants for a chat session. The potential chat participants may operate on network server computer 130. Alternatively, such chat participants can operate anywhere within distributed data processing environment 100 that has access to instant messaging program 132 on network server computer 130. Chat participant modifying program 134 may add, remove, or keep chat participants in a chat session, based on the signifiers found in instant messages received in the chat session.

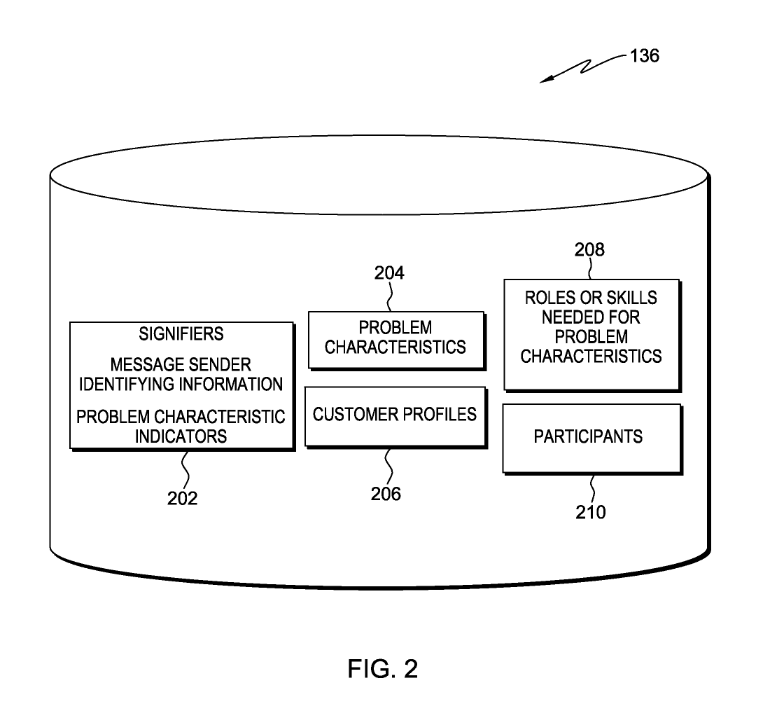

FIG. 2 is an exemplary depiction of stored information in a database, in accordance with an embodiment of the present invention. Database 136 includes signifiers 202, the presence of which in received instant messages in a chat session is determined by chat participant modifying program 134. Signifiers 202 can include problem characteristic indicators and message sender identifying information. Problem characteristic indicators stored in database 136 may include symbols, characters, images, user names, locations, words, such as “help”, and phrases, such as “having a problem with software A”.

Message sender identifying information stored in database 136 may include, for example, name, street address, IP address, user name, account number and password. Database 136 may also contain customer profiles 206. Customer profiles 206 may include profiles of customers who are also message senders identified by message sender identifying information. A customer profile included in customer profiles 206 may include an indication of whether a warranty was purchased, a customer's history with support staff, or a level of support to which a customer has access. Database 136 may include associations (not shown) between information in customer profiles 206 and various potential chat participants 210, and chat participant modifying program 134 may use this information to determine one or more potential chat participants 210 which may be included in a chat session. For example, a customer's profile in customer profiles 206 may indicate the customer's connection to a chat participant with whom the customer has successfully chatted with previously. The chat participant therefore has history with the customer, and instead of selecting another chat participant who has had no previous interaction with the customer, chat participant modifying program 134 will include the chat participant with success in the past as a potential chat participant for the chat session.

Database 136 may further include problem characteristics 204, which are indicated by problem characteristic indicators included in signifiers 202. Problem characteristics 204 may include problem type, such as technical support, sales concerns or warranty questions, severity of problem or business impact of problem. Database 136 may also include data regarding roles or skills 208 needed to address respective problem characteristics 204 and lists of potential chat participants 210. Database 136 may also include associations (not shown) between potential chat participants 210 and their respective various roles or skills 208. Chat participant modifying program 134 may use those of roles and skills 208 that are needed to determine potential chat participants suitable to address each problem characteristic 204 that chat participant modifying program 134 discerns from an instant message in the chat session.

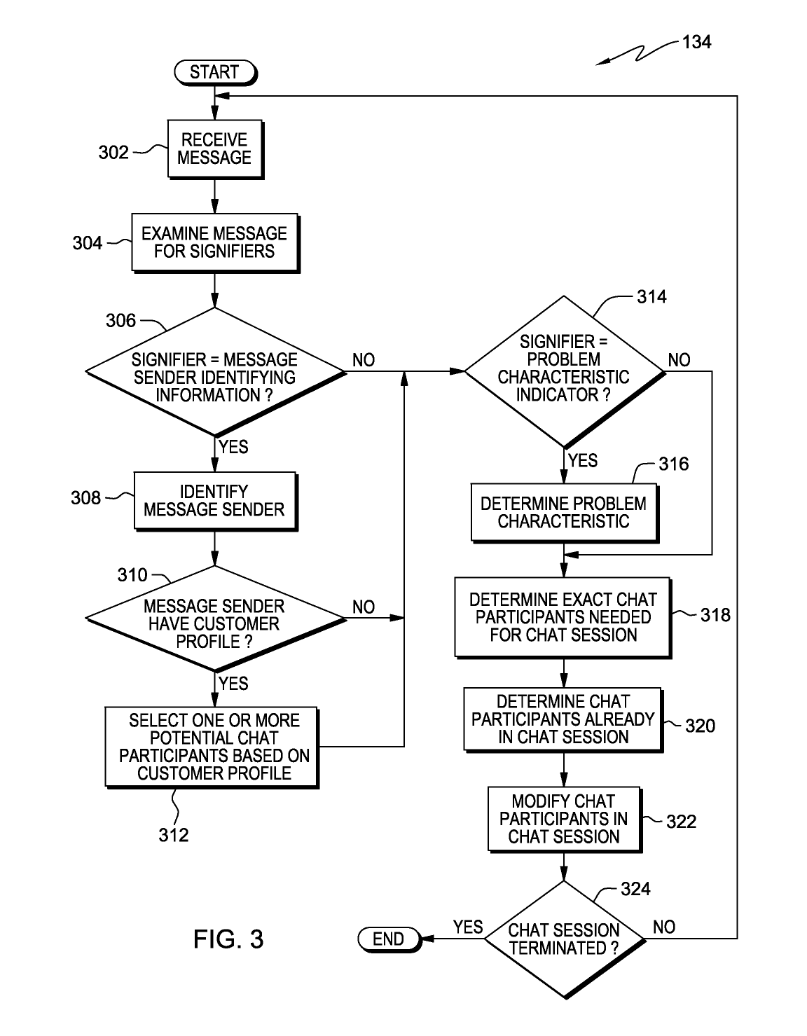

FIG. 3 is a flowchart illustrating the steps of a chat participant modifying program for dynamically modifying participants in an online chat session, in accordance with an embodiment of the present invention. In an embodiment, before chat participant modifying program 134 begins, a user activates chat client 112 to communicate with network server computer 130 via network 120. In various embodiments, the user is a customer who initiates a chat session by sending an instant message to introduce a technical support situation, or by opening a customer support ticket on a company's website. A support facilitator then replies to the instant message in the chat session. As used herein, a “support facilitator” is a representative of the organization with which the customer would like to chat. The support facilitator can operate anywhere within the distributed data processing environment 100 that has access to instant messaging program 132 on network server computer 130.

Chat participant modifying program 134 receives an instant message in a chat session from chat client 112 (step 302). In one embodiment, chat participant modifying program 134 receives the instant message from chat client 112 via instant messaging program 132.

Next, chat participant modifying program 134 examines the instant message for signifiers 202 (step 304). The signifiers 202 may be either message sender identifying information stored in database 136 or problem characteristic indicators stored in database 136.

If chat participant modifying program 134 finds message sender identifying information in the message (decision block 306, yes branch), then chat participant modifying program 134 proceeds to identify the message sender based on the message sender identifying information (step 308). Message sender identifying information may include name, street address, IP address, user name, account number or password. If chat participant modifying program 134 does not find message sender identifying information in the instant message (decision block 306, no branch), then chat participant modifying program 134 proceeds to step 314.

Chat participant modifying program 134 determines whether a customer profile associated with the identified message sender is stored in customer profiles 206 of database 136 (decision block 310). If chat participant modifying program 134 determines that there is no customer profile associated with the identified message sender stored in customer profiles 206 of database 136 (decision block 310, no branch), chat participant modifying program proceeds to step 314.

If chat participant modifying program 134 determines that a customer profile associated with the identified message sender is stored in customer profiles 206 of database 136 (decision block 310, yes branch), chat participant modifying program 134 selects one or more potential chat participants for the chat session based on the customer profile (step 312). Chat participant modifying program 134 may select the one or more potential chat participants based on a level of support that the identified message sender has purchased as a customer of the organization (for example, if a customer has purchased gold level support, the one or more potential chat participants may include upper level support staff members), a prior history that the identified message sender has with support staff of the organization, and/or a warranty that the identified message sender has purchased as a customer of the organization (for example, if a customer has purchased an extended warranty with additional coverage, the one or more potential chat participants may include additional service support staff than if the customer purchased a basic warranty). After chat participant modifying program 134 selects the one or more potential chat participants at step 312, chat participant modifying program 134 proceeds to step 314. In an embodiment, after selecting the one or more potential chat participants at step 312, chat participant modifying program 134 may proceed to step 318 to determine the exact chat participants for the chat session.

At step 314, chat participant modifying program 134 determines whether a signifier found in the examined message is a problem characteristic indicator. If chat participant modifying program 134 does not find a problem characteristic indicator in the message (decision block 314, no branch), chat participant modifying program 134 proceeds to step 318. If chat participant modifying program 134 finds a problem characteristic indicator in the message (decision block 314, yes branch), chat participant modifying program 134 proceeds to block 316.

Chat participant modifying program 134 determines the problem characteristic of problem characteristics 204 that is related to the found problem characteristic indicator (step 316). The problem characteristics indicators stored in signifiers 202 of database 136 are linked to respective problem characteristics 204, which may vary from problem type, severity of problem, or business impact of problem.

Next, chat participant modifying program 134 determines exact chat participants needed for the chat session (step 318). Chat participant modifying program 134 may determine the exact chat participants for the chat session based on the problem characteristic determined in step 316 and may select the exact chat participants from all potential chat participants, or chat participant modifying program 134 may determine the exact chat participants based on customer profile information and may select the exact chat participants from the one or more potential chat participants selected at step 312. To determine the exact chat participants based on the problem characteristic present in the chat session, chat participant modifying program 134 accesses those of roles and skills 208 associated with the problem characteristic present in the chat session and those of potential chat participants 210 associated with those of roles and skills 208.

Chat participant modifying program 134 may determine that the exact chat participants for the chat session are a subset of the one or more potential chat participants previously selected based on customer profile information at step 312. For example, the one or more potential chat participants from step 312 may include a chat participant the customer has successfully chatted with in the past and a chat participant selected based on the customer's geographic region. Chat participant modifying program 134 may determine, without the presence of other information, that the exact chat participant for the chat session is the chat participant having a history with the customer. Chat participants may include either individuals or teams. In the case of a chat participant team, a representative chat participant may be selected to be included in the chat session, as opposed to the entire team.

Chat participant modifying program 134 then determines the chat participants already participating in the chat session (step 320). Chat participants already in the chat session may be, for example, the customer and the support facilitator, or the chat session may have many chat participants currently working through a situation.

Next, chat participant modifying program 134 modifies the chat participants in the chat session (step 322). Chat participant modifying program 134 compares the exact chat participants determined at step 318 to the chat participants determined to be already in the chat session at step 320 and adjusts the chat participants accordingly. For example, chat participant modifying program 134 may add, to the chat session, an exact chat participant determined at step 318 who is not among the chat participants determined to be already in the chat session at step 320. As another example, chat participant modifying program 134 may remove, from the chat session, a chat participant determined to be already in the chat session at step 320 but not determined to be an exact chat participant at step 318. As another example, chat participant modifying program 134 may keep, in the chat session, an exact chat participant determined at step 318 who is among the chat participants determined to be already in the chat session at step 320.

After modifying the chat participants in the chat session, chat participant modifying program 134 determines whether the chat session has been terminated (decision block 324). Chat participant modifying program 134 may determine that the chat session has been terminated if, for example, there are no longer chat participants in the chat session. If chat participant modifying program 134 determines the chat session is terminated (decision block 324, yes branch), the method ends. If chat participant modifying program 134 determines the chat session is not terminated (decision block 324, no branch), chat participant modifying program 134 returns to block 302 to receive another instant message in the chat session.

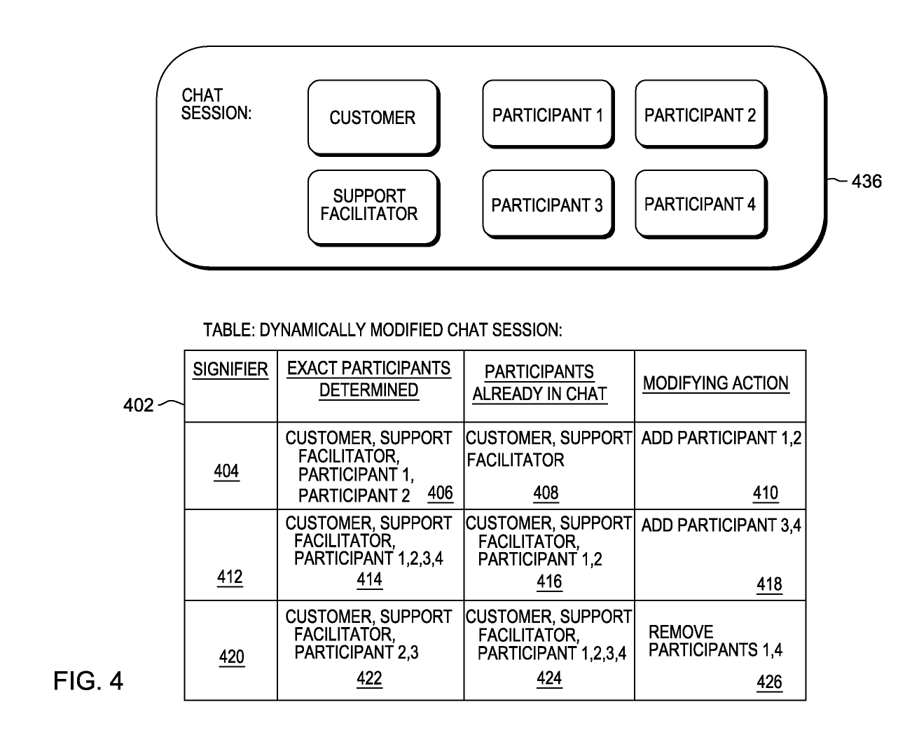

FIG. 4 provides an exemplary depiction of an online chat session populated using a chat participant modifying program, in accordance with an embodiment of the present invention. Chat participant modifying program 134 dynamically modifies the chat participants in an online chat session based on signifiers found in instant messages received in the chat session. In a preferred embodiment, a customer sends an initial instant message regarding a technical support situation, for example, an error code received while installing software. A support facilitator replies, which creates chat session 436 with the first two chat participants (the support facilitator and the customer), and chat participant modifying program 134 proceeds to modify chat participants in the chat session as discussed with reference to table 402.

Chat participant modifying program 134 examines instant messages received in chat session 436 for signifiers 202, which may be either message sender identifying information or problem characteristic indicators. In response to finding signifier 404, which may be message sender identifying information, chat participant modifying program 134 determines the exact chat participants needed for chat session 436 based on an associated customer profile (included in customer profiles 206) of the identified message sender. Exact participants 406 may be, for example, the customer, the support facilitator, and participants 1 and 2. Chat participant modifying program 134 may select chat participants 1 and 2 for the chat session based on a prior history with the customer. Chat participant modifying program 134 next determines participants 408 already in the chat session, here only the customer and the support facilitator, and performs a modifying action 410 by adjusting the chat participants in the chat session accordingly, for example by adding participants 1 and 2.

After performing modifying action 410, chat participant modifying program 134 returns to examine a subsequently received instant message in the chat session for additional signifiers 202. In response to finding signifier 412, for example, a problem characteristic indicator, chat participant modifying program 134 determines exact participants 414 needed to address the problem characteristic (of problem characteristics 204) indicated. An example of a problem characteristic indicator is a phrase such as “help with installing software A”, which may indicate a problem characteristic of problem characteristics 204 dealing with a type of software installation problem. Chat participant modifying program 134 may determine that potential chat participants for the chat session may be technical support staff with expertise in software installation troubleshooting. Chat participant modifying program 134 then proceeds to perform a modifying action 418 to modify the chat participants in the chat session based on the exact participants 414 determined for the chat session and participants 416 already in the chat session.

Chat participant modifying program 134 modifies chat participants in a chat session not only by adding chat participants, but also by removing chat participants no longer determined to be needed for the chat session. In response to finding signifier 420 in another subsequently received instant message in the chat session, chat participant modifying program 134 determines exact participants 422 needed for the chat session. Chat participant modifying program 134 determines participants 424 already in the chat session. Chat participant modifying program 134 compares the determined exact participants 422 and the participants 424 already in the chat session. In order to have the chat session populated with only the participants needed for the chat session, chat participant modifying program 134 performs a modifying action 426 to remove participants 1 and 4 from the chat session, allowing the remaining chat participants to continue to work through the situation present in the chat session.

FIG. 5 shows a block diagram of internal components 800a and external components 900a of user computing device 110 and internal components 800b and external components 900b of network server computer 130, in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

User computing device 110 and network server computer 130 include respective sets of internal components 800a,b and external components 900a,b illustrated in FIG. 5. Each of the sets of internal components 800a,b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 are stored on one or more of the respective computer-readable tangible storage devices 830 for execution by one or more of the respective processors 820 via one or more of the respective RAMs 822 (which typically include cache memory). Chat client 112 and user interface 114 are stored on one or more of the respective computer-readable tangible storage devices 830 of internal components 800a for execution by one or more of processors 820 of internal components 800a via one or more of the RAMs 822 of internal components 800a. Instant messaging program 132 and chat participant modifying program 134 are stored on one or more of the respective computer-readable tangible storage devices 830 of internal components 800b for execution by one or more of processors 820 of internal components 800b via one or more of the RAMs 822 of internal components 800b. In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a,b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Chat client 112 and user interface 114 can be stored on one or more of portable computer-readable tangible storage devices 936 of external components 900a, read via the R/W drive or interface 832 of internal components 800a and loaded into hard drive 830 of internal components 800a. Instant messaging program 132 and chat participant modifying program 134 can be stored on one or more of portable computer-readable tangible storage devices 936 of external components 900b, read via the R/W drive or interface 832 of internal components 800b and loaded into hard drive 830 of internal components 800b.

Each set of internal components 800a,b also includes network adapters or interfaces 836 such as TCP/IP adapter cards, wireless wi-fi interface cards, 3G or 4G wireless interface cards or other wired or wireless communication links. Chat client 112 and user interface 114 in user computing device 110 and instant messaging program 132 and chat participant modifying program 134 in network server computer 130 can be downloaded to user computing device 110 and network server computer 130, respectively, from an external computer via a network (for example, the Internet, a local area network or other, wide area network) and respective network adapters or interfaces 836. From the network adapters or interfaces 836, chat client 112 and user interface 114 in user computing device 110 and instant messaging program 132 and chat participant modifying program 134 in network server computer 130 are loaded into the respective hard drive 830. The network may comprise copper wires, optical fibers, wireless transmission, routers, firewalls, switches, gateway computers and/or edge servers.

Each of the sets of external components 900a,b can include a computer display monitor 920, a keyboard 930, and a computer mouse 934. External components 900a,b can also include touch screens, virtual keyboards, touch pads, pointing devices, and other human interface devices. Each of the sets of internal components 800a,b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the present invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java®, Smalltalk, C, and C++. The program code may execute entirely on the user's computer, partly on the user's computer, as a stand-alone software package, partly on the user's computer and partly on a server computer, or entirely on a server computer. In the latter scenario, the server computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer program product, system and method have been disclosed in accordance with the present invention. However, numerous modifications and substitutions can be made without deviating from the scope of the present invention. Such modifications and substitutions that may be apparent to a person skilled in the art of the invention are intended to be included within the scope of the invention as defined by the accompanying claims. In this regard, each block in the flowcharts or block diagrams may represent a module, segment, or portion of code, which comprises one or more executable instructions for implementing the specified logical function(s). The foregoing description is not intended to be exhaustive nor to limit the invention to the precise form disclosed. Therefore, the present invention has been disclosed by way of example and not limitation.

What is claimed is:

1. A method for managing an online chat session, the method comprising the steps of:
a computer examining an instant message received from a customer participating in the online chat session;
the computer determining that the examined instant message indicates a characteristic of a problem being experienced by the customer;
the computer determining, based on the characteristic of the problem, one or more chat participants to include in the online chat session to address the problem; and
the computer modifying a set of chat participants participating in the online chat session;
wherein the modifying comprises including the determined one or more chat participants in the set of chat participants.

2. The method of claim 1, further comprising the step of:
the computer determining one or more chat participants for the online chat session based on a customer profile of the customer;
wherein the customer profile includes at least one of a level of support that the customer has purchased, a prior history that the customer has with support staff, and a warranty that the customer has purchased.

3. The method of claim 1, wherein the characteristic of the problem is selected from the group consisting of a type of the problem, a severity of the problem, a business impact of the problem, and a system affected by the problem.

4. The method of claim 1, wherein the characteristic of the problem is associated with a skill set, and wherein the step of the computer determining the one or more chat participants further comprises the computer determining that the one or more chat participants have the skill set.

5. The method of claim 1, wherein the modifying step further comprises removing, from the set of chat participants, a chat participant who is not among the determined one or more chat participants.

6. The method of claim 1, further comprising the step of the computer selecting the one or more chat participants from a team comprised of a plurality of chat participants.

7. The method of claim 1, further comprising the steps of:
the computer examining a subsequent instant message received in the online chat session;
the computer determining that the examined subsequent instant message includes an other characteristic of a problem being experienced by the customer;
the computer determining one or more chat participants to include in the online chat session based on the other characteristic; and
the computer modifying the modified set of chat participants participating in the online chat session to include the one or more chat participants determined based on the other characteristic.

8. A computer program product for managing an online chat session, the computer program product comprising:
one or more computer readable-tangible storage devices and program instructions stored on at least one of the one or more computer readable-tangible storage devices, the program instructions comprising:
program instructions to examine an instant message received from a customer participating in the online chat session;
program instructions to determine that the examined instant message indicates a characteristic of a problem being experienced by the customer;
program instructions to determine, based on the characteristic of the problem, one or more chat participants to include in the online chat session to address the problem; and
program instructions to modify a set of chat participants participating in the online chat session;
wherein the program instructions to modify the set of chat participants comprise program instructions to include the determined one or more chat participants in the set of chat participants.

9. The computer program product of claim 8, further comprising:
program instructions, stored on at least one of the one or more computer readable-tangible storage devices, to determine one or more chat participants for the online chat session based on a customer profile of the customer;
wherein the customer profile includes at least one of a level of support that the customer has purchased, a prior history that the customer has with support staff, and a warranty that the customer has purchased.

10. The computer program product of claim 8, wherein the characteristic of the problem is selected from the group consisting of a type of the problem, a severity of the problem, a business impact of the problem, and a system affected by the problem.

11. The computer program product of claim 8, wherein the characteristic of the problem is associated with a skill set, and where the program instructions to determine the one or more chat participants comprise program instructions to determine that the one or more chat participants have the skill set.

12. The computer program product of claim 8, wherein the program instructions to modify the set of chat participants further comprise program instructions to remove, from the set of chat participants, a chat participant who is not among the determined one or more chat participants.

13. The computer program product of claim 8, further comprising program instructions, stored on at least one of the one or more computer readable-tangible storage devices, to select the one or more chat participants from a team comprised of a plurality of chat participants.

14. The computer program product of claim 8, further comprising:
program instructions, stored on at least one of the one or more computer readable-tangible storage devices, to examine a subsequent instant message received in the online chat session;
program instructions, stored on at least one of the one or more computer readable-tangible storage devices, to determine that the examined subsequent instant message include an other characteristic of a problem being experienced by the customer;
program instructions, stored on at least one of the one or more computer readable-tangible storage devices, to determine one or more chat participants to include in the online chat session based on the other characteristic; and
program instructions, stored on at least one of the one or more computer readable-tangible storage devices, to modify the modified set of chat participants participating in the online chat session to include the one or more chat participants determined based on the other characteristic.

15. A computer system for managing an online chat session, the computer system comprising:
one or more processors, one or more computer-readable memories, one or more computer readable-tangible storage devices and program instructions which are stored on the one or more computer readable-tangible storage devices for execution by the one or more processors via the one or more memories, the program instructions comprising:
program instructions to examine an instant message received from a customer participating in the online chat session;
program instructions to determine that the examined instant message indicates a characteristic of a problem being experienced by the customer;
program instructions to determine, based on the characteristic of the problem, one or more chat participants to include in the online chat session to address the problem; and
program instructions to modify a set of chat participants participating in the online chat session;
wherein the program instructions to modify the set of chat participants comprise program instructions to include the determined one or more chat participants in the set of chat participants.

16. The computer system of claim 15, further comprising:
program instructions, stored on the one or more computer readable-tangible storage devices for execution by the one or more processors via the one or more memories, to determine one or more chat participants for the online chat session based on a customer profile of the customer;
wherein the customer profile includes at least one of a level of support that the customer has purchased, a prior history that the customer has with support staff, and a warranty that the customer has purchased.

17. The computer system of claim 15, wherein the characteristic of the problem is selected from the group consisting of a type of the problem, a severity of the problem, a business impact of the problem, and a system affected by the problem.

18. The computer system of claim 15, wherein the characteristic of the problem is associated with a skill set, and where the program instructions to determine the one or more chat participants comprise program instructions to determine that the one or more chat participants have the skill set.

19. The computer system of claim 15, wherein the program instructions to modify the set of chat participants further comprise program instructions to remove, from the set of chat participants, a chat participant who is not among the determined one or more chat participants.

20. The computer system of claim 15, further comprising program instructions, stored on the one or more computer readable-tangible storage devices for execution by the one or more processors via the one or more memories, to select the one or more chat participants from a team comprised of a plurality of chat participants.

21. The computer system of claim 15, further comprising:
program instructions, stored on the one or more computer readable-tangible storage devices for execution by the one or more processors via the one or more memories, to examine a subsequent instant message received in the online chat session;
program instructions, stored on the one or more computer readable-tangible storage devices for execution by the one or more processors via the one or more memories, to determine that the examined subsequent instant message include an other characteristic of a problem being experienced by the customer;
program instructions, stored on the one or more computer readable-tangible storage devices for execution by the one or more processors via the one or more memories, to determine one or more chat participants to include in the online chat session based on the other characteristic; and
program instructions, stored on the one or more computer readable-tangible storage devices for execution by the one or more processors via the one or more memories, to modify the modified set of chat participants participating in the online chat session to include the one or more chat participants determined based on the other characteristic.
